(19) United States
(12) Patent Application Publication
(10) Pub. No.: US 2022/0279788 A1
(43) Pub. Date: Sep. 8, 2022

(54) EMULSIFIABLE CONCENTRATE FORMULATIONS AND THEIR USES

(71) Applicant: JIANGSU ROTAM CHEMISTRY CO., LTD., Suzhou, Jiangsu (CN)

(72) Inventor: James Timothy Bristow, Chai Wan (HK)

(21) Appl. No.: 17/628,354

(22) PCT Filed: Jul. 23, 2019
(86) PCT No.: PCT/CN2019/097194

§ 371 Date: Jan. 19, 2022

(51) Int. Cl. A01N 43/50; A01N 25/04; A01N 43/56; A01N 43/38; A01N 37/34; A01N 43/22; A01P 7/02; A01P 13/00

(52) U.S. Cl. CPC A01N 43/50; A01N 25/04; A01N 43/56; A01N 43/38; A01N 37/34; A01N 43/22; A01P 7/02; A01P 13/00

(57) ABSTRACT

An agrochemical emulsifiable concentrate (EC) formulation is provided. The formulation comprises:
A: an agrochemically active compound;
B: a solvent system comprising:
   a) a saturated monohydric alcohol having 1 to 10 carbon atoms; and
   b) a fatty acid ester; and
C: an emulsifier.

A method for preparing the formulation and methods for its use in controlling pest infestations are also provided. A method for improving the particle size distribution of emulsified oil droplets of an emulsifiable concentrate (EC) formulation comprising mixing an agrochemically active compound with a solvent system comprising:
a): a saturated monohydric alcohol having 1 to 10 carbon atoms; and
b): a fatty acid ester, is also provided.

This U.S. national stage patent application claims priority to international patent application no. PCT/CN2019/097194, filed Jul. 23, 2019, the entire contents of which is incorporated herein by reference in its entirety.

### BACKGROUND

### 1. Technical Field

The present invention relates emulsifiable concentrate (EC) formulations, in particular agrochemical EC formulations, and to a method for preparing the same. The present invention further relates to a method for protecting and treating plants, plant parts and/or their surroundings using the EC formulations.

### 2. Related Art

Agrochemically active compounds are generally formulated as solid particles, including particles of crystalline or amorphous solids, or oily liquids, which are non-dispersible or difficult to disperse in water. However, before the formulations are applied to the plants, plant parts and/or plant surroundings to be treated, they are first prepared as an aqueous dispersion, solution or suspension.

One type of formulation frequently used for agrochemically active compounds, such as herbicides, insecticides and microbicides, is an emulsifiable concentrate (EC) formulation. EC formulations are prepared by dissolving the active compound in a water-immiscible solvent, typically in combination with one or more emulsifiers, to form the emulsifiable concentrate (EC) formulations. When an EC formulation is to be applied in the field, the formulation is usually diluted with a large amount of water and agitated to form a stable emulsion. The emulsion is then sprayed onto the plants or locus to be treated with a sprayer.

The efficacy of emulsifiable concentrate (EC) formulation is dependent on a number of factors, in particular the extent of emulsification of the formulation after adding to water. An indicator of the extent of emulsification is the particle size distribution and size of the emulsified oil droplets in the aqueous dilution. Uniformity and size of droplets directly affect the permeability of the agrochemically active compounds and the final efficacy of the formulation. In general, after dilution and dispersion on water, the emulsified oil droplets from emulsifiable concentrate (EC) formulations have an average particle size of from 500 nm to 1000 nm, and even 1000 nm or more. Typically, the dispersions exhibit a wide particle size distribution. Dispersed oil droplets with a large particle size do not help the penetration of agrochemically active compounds. As a result, a portion of the agrochemically active compounds applied using the formulation would be wasted and ultimately discharged into the environment.

There is a need for further improvement in emulsifiable concentrate (EC) formulations, for example to increase the efficacy of the formulation once applied, reduce discharging of agrochemically active compounds and alleviate negative impacts on the environment.

### SUMMARY

It has unexpectedly been found that mixing an agrochemically active compound with a solvent system comprising a saturated monohydric alcohol having 1 to 10 carbon atoms, a fatty acid ester, and an emulsifier, can effectively improve the particle size distribution of the emulsified oil droplets, thereby significantly improving the efficacy of the EC formulation.

In a first aspect, the present invention provides an agrochemical formulation comprising:

A: an agrochemically active compound; and

B: a solvent system comprising:
a) a saturated monohydric alcohol solvent having from 1 to 10 carbon atoms; and
b) a fatty acid ester; and

C: an emulsifier.

It has been found that the solvent system employed in the formulation of the present invention can dissolve a large number of known types of agrochemically active compounds. Further, the formulation can be easily dispersed in water to form a stable emulsion. The particle size of the emulsified oil droplets is uniform and is in the range of from about 10 to about 100 nm. Further, once the formulation is applied to plants, the uptake of the agrochemically active compound through the leaves is significantly enhanced, resulting in a markedly improved biological effect.

In a further aspect of the invention there is provided a method for controlling or improving the particle size distribution of emulsified oil droplets comprising an agrochemically active compound of an emulsifiable concentrate (EC) formulation when the formulation is dispersed in water, the method comprising mixing the agrochemically active compound with a solvent system comprising:

a) a saturated monohydric alcohol having 1 to 10 carbon atoms; and

b) a fatty acid ester.

The formulation may comprise one or more adjuvants or components as generally employed in agrochemical EC formulations.

In another aspect, the present invention provides a crop treatment composition comprising the agrochemical formulation hereinbefore described and a carrier, such as water.

The methods and formulations described herein provide a method for improving the efficacy of an agrochemically active compound or a combination of agrochemically active compounds.

In another aspect, the present invention discloses a method for treating or protecting a plant and/or plant parts from a pest, comprising contacting the plant, plant parts and/or their surrounding with the agrochemical formulation or the crop treatment composition hereinbefore described.

In a still further aspect, the present invention provides the use of a solvent system comprising:

a) a saturated monohydric alcohol having 1 to 10 carbon atoms; and

b) a fatty acid ester

to improve the dispersion of an emulsifiable concentrate (EC) formulation comprising an agrochemically active compound.

In a still further aspect, the present invention provides the use of a solvent system comprising:

a) a saturated monohydric alcohol having 1 to 10 carbon atoms; and

b) a fatty acid ester

to improve the efficacy of an emulsifiable concentrate (EC) formulation comprising an agrochemically active compound in controlling pest infestations in a plant.

### DETAILED DESCRIPTION OF EXAMPLE EMBODIMENTS

The solvent system employed in the present invention comprises a saturated monohydric alcohol solvent having from 1 to 10 carbon atoms and a fatty acid ester.

The fatty acid ester is preferably one having a general formula of R—COO—CₙH₂ₙ₊₁, in which 1≤n≤10 and R is a linear and/or branched C₉-C₁₉ alkyl and/or alkenyl.

The concentrations of the various components in the EC formulation may vary.

In the EC formulation composition of the present invention, the agrochemically active compound may be present in any suitable amount sufficient to provide the required activity in controlling the target pests. Preferably, the agrochemical active compound is present in an amount of from about 0.1 wt % to about 10 wt %, more preferably from about 0.2 wt % to about 8 wt %, and still more preferably from about 0.5 wt % to about 5 wt % of the formulation.

The solvent system comprises a saturated monohydric alcohol having from 1 to 10 carbon atoms. The saturated monohydric alcohol having 1 to 10 carbon atoms may be present in the EC formulation in any suitable amount to provide the required solubility of the agrochemically active compound. The saturated monohydric alcohol is preferably present in the formulation in an amount of at least 5 wt %, more preferably at least 10 wt %, still more preferably at least 15 wt %, more preferably still at least 20 wt %. The saturated monohydric alcohol is preferably present in the formulation in an amount of up to 80 wt %, more preferably up to 70 wt %, still more preferably up to 60 wt %. The saturated monohydric alcohol is preferably present in the formulation in an amount of from about 10 wt % to about 60 wt %, more preferably from about 20 wt % to about 50 wt % of the formulation.

The formulation may comprise a single saturated monohydric alcohol or two or more saturated monohydric alcohols.

The solvent system further comprises a fatty acid ester. The fatty acid ester may be present in the EC formulation in any suitable amount which, when combined with the saturated monohydric alcohol, provides the required solubility for the agrochemically active compound. The fatty acid ester is preferably present in the formulation in an amount of at least 3 wt %, more preferably at least 5 wt %, still more preferably at least 10 wt %. The ester is preferably present in the formulation in an amount of up to 50 wt %, more preferably up to 40 wt %, still more preferably up to 30 wt %. Preferably, the fatty acid ester is present in the formulation in an amount of from about 5 wt % to about 40 wt %, preferably from about 10 wt % to about 30 wt % of the formulation.

The formulation may comprise a single fatty acid ester or two or more fatty acid esters.

The weight ratio of the saturated monohydric alcohol to the fatty acid ester is preferably about 15:1 to 1:15, more preferably about 12:1 to 1:12, still more preferably about 4:1 to 1:4, more preferably still about 4:1 to 1:1, for example from about 4:1 to 2:1, especially about 3.5:1 to 2:1.

The weight ratio of the fatty acid ester to the agrochemically active compound is preferably about 15:1 to 1:15. Preferably, the weight ratio of the fatty acid ester to the agrochemically active compound is greater than 1:1, more preferably about 15:1 to 1:1, still more preferably about 10:1 to 1:1, more preferably still about 10:1 to 2:1, for example from about 8:1 to 2:1, especially about 7:1 to 2:1.

The weight ratio of the monohydric alcohol to the agrochemically active compound is preferably about 50:1 to 1:15. Preferably, the weight ratio of the monohydric alcohol to the agrochemically active compound is greater than 1:1, more preferably from about 45:1 to 1:1, still more preferably about 40:1 to 1:1, more preferably still about 35:1 to 1:1, for example from about 30:1 to 1:1, especially about 30:1 to 1.2:1.

The EC formulation of the present invention comprises one or more emulsifiers. The emulsifier may be present in the EC formulation in any suitable amount to provide a stable emulsion when the formulation is dispersed in a carrier, in particular water. The emulsifier is preferably present in the formulation in an amount of at least 3 wt %, more preferably at least 5 wt %, still more preferably at least 10 wt %. The emulsifier is preferably present in the formulation in an amount of up to 50 wt %, more preferably up to 45 wt %, still more preferably up to 40 wt %. Preferably, the emulsifier is present in the formulation in an amount of from about 5 wt % to about 50 wt %, preferably from about 10 wt % to about 40 wt % of the formulation.

The formulation may comprise a single emulsifier or two or more emulsifiers.

One or more other acceptable additives may be present in the formulation in suitable amounts depending upon the type of additive and its function. For example, other additives may be present in the formulation in an amount to from 0 wt % to about 20 wt %, preferably from about 0.5 wt % to about 10 wt % of the formulation.

In many preferred embodiments of the formulation of the present invention, the components of the formulation are present in the following amounts and forms:

A: about 0.1 wt % to about 10 wt % of the agrochemically active compound,

B: about 10 wt % to about 60 wt % of the saturated monohydric alcohol solvent having 1 to 10 carbon atoms,

C: about 5 wt % to about 40 wt % of the fatty acid ester cosolvent having the general formula of R—COO—CₙH₂ₙ₊₁, in which 1≤n≤10 and R is a linear and/or branched C₉-C₁₉ alkyl and/or alkenyl,

D: about 5 wt % to about 50 wt % of the emulsifier, and

E: optionally, one or more other agrochemically acceptable additives.

The invention further provides a method for preparing the formulation of the invention, the preparation method comprising the steps of:
(a) dissolving the agriculturally active compound in a solvent system comprising a mixture of one or more saturated monohydric alcohol and one or more fatty acid esters;
(b): adding one or more emulsifiers and optionally one or more agrochemically acceptable additives while stirring to obtain a final mixture; and
(c): mixing the final mixture obtained in the step (b) uniformly by stirring to form a uniform solution.

Suitable agrochemically active compounds for inclusion in the formulation of the present invention are known in the art, with many being commercially available. Suitable agrochemically active compounds include insecticides, acaricides, nematicides, fungicides and herbicides. The formulation may comprise a single agrochemically active compound or a mixture of two or more agrochemically active compounds, which may have the same or different activities.

Suitable insecticides include abamectin, spinosad, spinetoram, imidacloprid, chlorpyrifos, clothianidin, thiacloprid, thiamethoxam, nitenpyram, acetamiprid, dinotefuran, lufenuron, bifenthrin, cyperimethrin, deltamethrin, permethrin, fenpropathrin, cyfluthrin, lambda-cyhalothrin, methiocarb, thiodicarb, aldicarb, emamectin benzoate, ivermectin, diflubenzuron, flucycloxuron, flufenoxuron, penfluron, teflubenzuron, triflumuron, pyriproxyfen, chrmafenozide, halofenozide, methoxyfenozide, tebufenozide, fufenozide, flonicamid, diafenthiuron, amitraz, beta-cyfluthrin, tefluthrin, etoxazole, spirotetramat, bifenazate, methoxyfenozide, pyridaphenthion and thiosultap-monosodium.

Suitable acaricides include propargite, azocyclotin, hexythiazox, pyridaben, fenbutatin oxide, dicofol, etoxazole, abamectin, spiroesifen, lufenuron and spirotetramat.

Suitable fungicides include tebuconazole, prothioconazole, benalaxyl, metalaxyl, ofurace, oxadixyl, 4-dodecyl-2,6-dimethyl morpholine (aldimorph), dodine, dodemorph, fenpropimorph, fenpropidin, guazatine, iminoctadine, spiroxamine, tridemorph, pyrimethanil, mepanipyrim, cyprodinil, cycloheximide, griseofulvin, kasugamycin, natamycin, polyoxin, streptomycin, bitertanol, bromoconazole, cyproconazole, difenoconazole, dinitroconazole, fenbuconazole, fluquinconazole, flusilazole, hexaconazole, imazalil, myclobutanil, penconazole, propiconazole, prochloraz, triadimefon, triadimenol, triflumizole, triticonazole, 5-chloro-7-(4-methylpiperidin-1-yl)-6-(2,4,6-trifluorophenyl)-[1,2,4]triazolo[1,5-a]pyrimidine, iprodione, myclozolin, procymidone, vinclozolin, ferbam, nabam, maneb, mancozeb, metam, metiram, propineb, polycarbamate, thiram, ziram, zineb, anilazine, benomyl, boscalid, carbendazim, carboxin, oxycarboxin, cyazofamid, dazomet, dithianon, famoxadone, fenamidone, fenarimol, fuberidazole, flutolanil, furametpyr, mepronil, nuarimol, probenazole, proquinazid, pyrifenox, pyroquilon, quinoxyfen, silthiofam, thiabendazole, thifluzamide, thiophanate-methyl, tiadinil, tricyclazole, Bordeau mixture, copper acetate, copperoxychloride, basic copper sulfate, fenpiclonil, fludioxonil, captafol, aptan, dichlofluanid, folpet, tolylfluanid, dimethomorph, flumetover, flumorph, azoxystrobin, dimoxystrobin, fluoxastrobin, kresoxim-methyl, metominostrobin, orysastrobin, picoxystrobin, trifloxystrobin, acibenzolar-S-methyl, benthiavalicarb, carpropamid, chlorothalonil, cyflufenamid, cymoxanil, diclomezine, diclocymet, diethofencarb, edifenphos, ethaboxam, fenhexamid, fenoxanil, ferimzone, fluazinam, fosetyl-aluminum, iprovalicarb, hexachlorobenzene, metrafenone, pencycuron, propamocarb, phthalide, tolclofos-methyl, quintozene and zoxamid.

Suitable herbicides include acifluorfen, aclonifen, alachlor, allidochlor, alloxydim, ametryn, amicarbazone, aminopyralid, amitrole, ammonium sulfamate, ancymidol, anilofos, asulam, atrazine, azafenidin, benfuresate, bentazone, benzfendizone, benzobicyclon, benzofenap, benzofluor, bicyclopyrone, bispyribac-sodium, bromoxynil, butachlor, butafenacil, butralin, cafenstrole, carbetamide, carfentrazone, chlorotoluron, clethodim, clomazone, clomeprop, clopyralid, cyanazine, cyclanilide, cycloxydim, cyprazole, daimuron/dymron, dicamba, diclofop-methyl, diclofop-P-methyl, diclosulam, diethatyl/diethatyl-ethyl, diflufenican, diflufenzopyr/diflufenzopyr-sodium, dimefuron, dimepiperate, dimethachlor, dimethametryn, diphenamid, dipropetryn, diquat, diuron, ethephon, etobenzanid, fenoxaprop, fenoxaprop-P, fenoxaprop-ethyl, fentrazamide, flazasulfuron, florasulam, fluazifop, fluazifop-P, fluazifop-butyl, fluazifop-P-butyl, fluazolate, flufenacet, flumetralin, flumetsulam, flumioxazin, flumipropyn, fluometuron, fluorodifen, fluoroglycofen, fluoroglycofen-ethyl, flupoxam, flupyrsulfuron, fluridone, flurochloridone, fluroxypyr, flurtamone, fluthiamide, fomesafen, halosafen, halosulfuron/halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, imazamethabenz/imazamethabenz-methyl, imazamox/imazamox-ammonium, imazapic, imazapyr/imazapyr-isopropyl-ammonium, imazaquin/imazaquin-ammonium, imazethapyr/imazethapyr-ammonium, ioxynil, isoproturon, isoxaben, isoxachlortole, isoxaflutole, isoxapyrifop, lactofen, lenacil, mefenacet, mefluidide, mepiquat-chloride, mesotrione, methabenzthiazuron, metamifop, metamitron, metazachlor, methazole, methoxyphenone, methyldymron, metosulam, metoxuron, metribuzin, molinate, monuron, napropamide, nicosulfuron, oxadiargyl, oxadiazon, oxaziclomefone, oxyfluorfen, pendimethalin, pentoxazone, pethoxamid, picloram, picolinafen, pinoxaden, piperophos, pretilachlor, probenazole, profluazol, prifluraline, profoxydim, prometryn, propanil, propazine, propham, propyrisulfuron, propyzamide, prosulfocarb, prynachlor, pyraclonil, pyraflufen/pyraflufen-ethyl, pyribambenz-isopropyl, pyribambenz-propyl, pyribenzoxim, pyributicarb, pyriftalid, pyriminobac/pyriminobac-methyl, pyrimisulfan, pyrithiobac/pyrithiobac-sodium, pyroxasulfone, pyroxsulam, quinchlorac, quinmerac, quizalofop, quizalofop-P, quizalofop-P-ethyl, saflufenacil, secbumeton, sethoxydim, siduron, sulcotrione, sulfentrazone, thidiazuron, thiobencarb, tiocarbazil, triaziflam, trichloroacetic acid (TCA), triclopyr, tridiphane, trifluralin, trimeturon,trinexapac/trinexapac-ethyl and uniconazole.

Preferred agrochemically active compounds include abamectin, emamectin benzoate, spinosad, spinetoram, imidacloprid, spirotetramat, oxyfluorfen, cyhalofop-butyl, diflufenican, metribuzin, pyriproxyfen, oxadiazon, and any combination thereof.

The term ‘saturated monohydric alcohol having 1 to 10 carbon atoms’ refers to an aliphatic or alicyclic saturated monohydric alcohol having from 1 to 10 carbon atoms, preferably an aliphatic or alicyclic saturated monohydric alcohol having from 2 to 9 carbon atoms, and more preferably an aliphatic or alicyclic saturated monohydric alcohol having from 3 to 8 carbon atoms, still more preferably an aliphatic or alicyclic saturated monohydric alcohol having from 4 to 8 carbon atoms, more preferably still an aliphatic or alicyclic saturated monohydric alcohol having from 6 to 8 carbon atoms. Suitable saturated monohydric alcohols are, for example, methanol, ethanol, propanol, isopropanol, butanol, n-butanol, iso-butanol, pentanol, n-pentanol, iso-pentanol, cyclopentanol, hexanol, n-hexanol, iso-hexanol, cyclohexanol, heptanol, isoheptanol, cyclohexyl methanol, octanol, n-octanol, iso-octanol, nonanol and decanol. In many preferred embodiments, the saturated monohydric alcohol of the formula R—OH, in which R is a straight chain or branched alkyl moiety having from 3 to 8 carbon atoms or a saturated cyclic group having from 3 to 8 carbon atoms.

Preferred fatty acid esters are esters of the general formula of R—COO—CₙH₂ₙ₊₁, in which 1≤n≤10, R is a linear and/or branched C₉-C₁₉ alkyl and/or alkenyl, and “n” is preferably from 1 to 6, more preferably from 1 to 4. The fatty acid ester complying with the above-mentioned formula is typically an ester formed from a C₁-C₆ alkyl monohydric alcohol, providing the CₙH₂ₙ₊₁ moiety, and a C₁₀-C₂₀ fatty acid, providing the R— moiety in the aforementioned formula.

The C₁-C₆ alkyl monohydric alcohol may be methanol, ethanol, propanol, iso-propanol, butanol, iso-butanol, sec-butanol, tert-butanol, pentanol, or hexanol.

The moiety R is a linear and/or branched C₉-C₁₉ alkyl and/or alkenyl which may be nonyl, CH₃(CH₂)₇CH═CH(CH₂)₁₁, C₁₀ alkyl, C₁₃ alkyl, C₁₅ alkyl, C₁₇ alkyl, CH₃(CH₂)₇CH═CH(CH₂)₇, CH₃(CH₂)₄CH═CHCH₂CH═CH(CH₂)₇, CH₃(CH₂)₄CH═CHCH₂CH═CHCH₂CH═CH(CH₂)₄, or C₁₉ alkyl. The C₁₀-C₂₀ fatty acid may be decanoic acid, erucic acid, lauric acid, myristic acid, palmitic acid, stearic acid, oleic acid, linoleic acid, linolenic acid, arachidic acid or the like.

The fatty acid ester is preferably methyl oleate (C₁₇H₃₃COOCH₃), ethyl palmitate (C₁₅H₃₁COOC₂H₅), methyl laurate (C₁₁H₂₃COOCH₃), ethyl myristate (C₁₃H₂₇COOC₂H₅), butyl linoleate (C₉H₃₁COOC₄H₉), propyl linoleate (C₁₇H₃₁COOC₃H₇), or ethyl stearate (C₁₇H₃₅COOC₂H₅).

The solvent system of the formulation of the present invention may comprise one or more further solvents. For example, the solvent system may include a polyhydric alcohol, such as propylene glycol or glycerol.

Suitable emulsifiers for use in the present invention are known in art and are commercially available. The emulsifier may be any emulsifier suitable for forming a stable emulsifiable concentrate (EC) formulation of an active agrochemical compound.

Suitable emulsifiers for inclusion in the formulation include ionic and non-ionic emulsifiers, for example, fatty alcohol polyoxyethylene ethers, polyoxyethylene alkyl aryl ethers, polyoxyethylene higher fatty acid esters, phosphates of polyoxyethylene alcohols or phenols, fatty acid esters of polyols, alkylaryl sulfonic acids, naphthalenesulfonic acid polymers, lignin sulfonates, polymeric comb-shaped branched copolymers, butylnaphthalenesulfonates, alkylaryl sulfonates, sodium alkyl sulfosuccinate, oils and fats, condensates of fatty alcohols and ethylene oxide, alkyltaurates, polyacrylic acid salts, and protein hydrolysates. Preferred emulsifiers include calcium dodecyl benzenesulfonate, castor oil ethoxylate, dodecyl benzenesulfonate, fatty alcohol ethoxylated and sodium alkyl sulfosuccinate.

The formulation of the present invention may further comprise any agrochemically acceptable additive, as known in the art for inclusion in an emulsifiable concentrate (EC) formulation, for example, anti-freezing agents, defoaming agents, antioxidants, penetrants, colorants, stabilizers, dispersants, wetting agents and the like.

As discussed above, in use, the formulation of the present invention is dispersed in a carrier to form an emulsion. The carrier comprises a solvent system that is immiscible with the solvent system of the formulation. The carrier is most suitably water. Upon dilution with water, the formulation of the present invention can be emulsified with agitation to form oil droplets with a particle size of about 10-100 nm suspended in water and uniformly distributed, thereby forming a spray mixture.

The particle size D₉₉ of the oil droplets ranges from about 10-100 nm, more preferably from 10-90 nm. Preferred oil droplet D₉₉ particle size ranges are 10-80 nm, 10-70 nm, 10-65 nm, 10-60 nm, 10-55 nm, 10-50 nm, 10-45 nm, 10-40 nm, 15-100 nm, 15-90 nm, 15-80 nm, 15-70 nm, 15-65 nm, 15-60 nm, 15-55 nm, 15-50 nm, 15-45 nm, 15-40 nm, 20-100 nm, 20-90 nm, 20-80 nm, 20-70 nm, 20-65 nm, 20-60 nm, 20-55 nm, 20-50 nm, 20-45 nm, 20-40 nm, 25-100 nm, 25-90 nm, 25-80 nm, 25-70 nm, 25-65 nm, 25-60 nm, 25-55 nm, 25-50 nm, 25-45 nm, 25-40 nm, 30-100 nm, 30-90 nm, 30-80 nm, 30-70 nm, 30-65 nm, 30-60 nm, 30-55 nm, 30-50 nm, 30-45 nm, 30-40 nm, 35-100 nm, 35-90 nm, 35-80 nm, 35-70 nm, 35-65 nm, 35-60 nm, 35-55 nm, 35-50 nm, 35-45 nm, 35-40 nm, 40-100 nm, 40-90 nm, 40-80 nm, 40-70 nm, 40-65 nm, 40-60 nm, 40-55 nm, 40-50 nm, 40-45 nm, 45-100 nm, 45-90 nm, 45-80 nm, 45-70 nm, 45-65 nm, 45-60 nm, 45-55 nm, 45-50 nm, and 45-58 nm.

The particle size D₅₀ of the oil droplets ranges from about 10-100 nm, more preferably from 10-90 nm. Preferred oil droplet D₅₀ particle size ranges are 10-80 nm, 10-70 nm, 10-65 nm, 10-60 nm, 10-55 nm, 10-50 nm, 10-45 nm, 10-40 nm, 10-35 nm, 10-30 nm, 10-25 nm, 15-100 nm, 15-90 nm, 15-80 nm, 15-70 nm, 15-65 nm, 15-60 nm, 15-55 nm, 15-50 nm, 15-45 nm, 15-40 nm, 15-35 nm, 15-30 nm, and 15-25 nm.

The formulation of the present invention can be used to treat plants, plant parts and/or their surroundings.

“Plant” as used herein, refers to all plants and plant populations, for example, wild plants or crop plants. Crop plants can be plants obtained by conventional breeding and optimization or by biotechnological and recombinant methods.

“Plant parts” as used herein, refers to all above-ground or underground parts of plants and plant organs, such as buds, leaves, flowers and roots, and examples of the plant part that may be mentioned are leaves, needle leaves, stems, stems, flowers, fruiting bodies, fruits and seeds, as well as roots, tubers and rhizomes. The plant parts also include harvested materials, as well as vegetative and generative propagation materials such as cuttings, tubers, rhizomes, branches and seeds.

“Surroundings” as used herein, refers to the place on which the plants are growing, the place on which the plant propagation materials of the plants are sown or the place on which the plant propagation materials of the plants will be sown.

The treatment of plants and plant parts with the formulation of the invention diluted with water according to the invention can be carried out directly or according to conventional treatment methods. The treatment method is performed by spraying.

Embodiments of the present invention will now be further described by way of the following working examples.

The following examples are given by way of illustration and should not be construed to limit the invention.

Percentages are percentage by weight of the formulation or composition, unless otherwise indicated.

### EXAMPLES

### Example 1

An emuslifiable concentrate (EC) formulation of abamectin 1.8% was prepared from the following components:

| | |
|---|---|
| Abamectin | 1.8% |
| N-hexanol | 40% |
| Methyl oleate | 12% |
| Castor oil ethoxylate | 38% |
| BHT (antioxidant) | 1% |
| Acetic acid | 0.5% |
| Propylene glycol | 6.7% |

N-hexanol and methyl oleate were mixed uniformly to form a solvent system. Abamectin was added and stirred until dissolved. Castor oil ethoxylate, BHT (antioxidant), acetic acid and propylene glycol were then added, and the mixture stirred uniformly to obtain a formulation.

### Example 2

An emuslifiable concentrate (EC) formulation of emamectin benzoate 10% was prepared from the following components:

| | |
|---|---|
| Emamectin benzoate | 10% |
| N-octanol | 40% |
| Ethyl palmitate | 20% |
| Calcium dodecyl benzenesulfonate | 20% |
| Propylene glycol | 10% |

N-octanol and ethyl palmitate were mixed uniformly to form a solvent system. Emamectin benzoate was added and stirred until dissolved. Dodecyl benzenesulfonate and propylene glycol were then added, and the mixture stirred uniformly to obtain a formulation.

### Example 3

An emuslifiable concentrate (EC) formulation of imidacloprid 2% was prepared from the following components:

| | |
|---|---|
| Imidacloprid | 2% |
| Butanol | 60% |
| Methyl laurate | 5% |
| Castor oil ethoxylate | 30% |
| BHT (antioxidant) | 3% |

Butanol and methyl laurate were mixed uniformly to form a solvent system. Imidacloprid was added and stirred until dissolved. Castor oil ethoxylate and BHT (antioxidant) were then added and the mixture stirred uniformly to obtain a formulation.

### Example 4

An emuslifiable concentrate (EC) formulation of pyraclostrobin 8% was prepared from the following components:

| | |
|---|---|
| Pyraclostrobin | 8% |
| Cyclohexanol | 10% |
| Ethyl myristate | 40% |
| Sodium alkyl sulfosuccinate | 40% |
| BHT (antioxidant) | 2% |

Cyclohexanol and ethyl myristate were mixed uniformly to form a solvent system. Pyraclostrobin was added and stirred until dissolved. Sodium alkyl sulfosuccinate and BHT (antioxidant) were then added, and the resulting stirred uniformly to obtain a formulation.

### Example 5

An emuslifiable concentrate (EC) formulation of spirotetramat 5% was prepared from the following components:

| | |
|---|---|
| Spirotetramat | 5% |
| Iso-propanol | 40% |
| Butyl linoleate | 10% |
| Dodecyl benzenesulfonate | 35% |
| Propylene glycol | 10% |

Iso-propanol and butyl linoleate were mixed uniformly to form a solvent system. Spirotetramat was added and stirred until dissolved. Dodecyl benzenesulfonate and propylene glycol were then added and the mixture stirred uniformly to obtain a formulation.

### Example 6

An emuslifiable concentrate (EC) formulation of cyhalofop-butyl 10% was prepared from the following components:

| | |
|---|---|
| Cyhalofop-butyl | 10% |
| Cyclopentanol | 15% |
| Propyl linoleate | 30% |
| Castor oil ethoxylate | 40% |
| Glycerol | 5% |

Cyclopentanol and propyl linoleate were mixed uniformly and cyhalofop-butyl was added and stirred until dissolved. Castor oil ethoxylate and glycerol were then added and the resulting mixture stirred uniformly to obtain a formulation.

### Example 7

An emuslifiable concentrate (EC) formulation of pyraflufen-ethyl 5% was prepared from the following components:

| | |
|---|---|
| Pyraflufen-ethyl | 5% |
| Iso-heptanol | 40% |
| Methyl oleate | 12% |
| Calcium dodecyl benzenesulfonate | 40% |
| BHT (antioxidant) | 1% |
| Citric acid | 2% |

Iso-heptanol and methyl oleate were mixed uniformly. Pyraflufen-ethyl was added and stirred until dissolved. Calcium dodecyl benzenesulfonate, BHT (antioxidant) and citric acid were then added and the resulting mixture stirred uniformly to obtain a formulation.

### Example 8

An emuslifiable concentrate (EC) formulation of abamectin 1% and imidacloprid 2% was prepared from the following components:

| | |
|---|---|
| Abamectin | 1% |
| Imidacloprid | 2% |
| Cyclohexanol | 40% |
| Ethyl stearate | 20% |
| Fatty alcohol ethoxylate | 35% |
| Citric acid | 2% |

Cyclohexanol and ethyl stearate were mixed uniformly to form a solvent system. Thereafter, abamectin and imidacloprid were added and stirred until dissolved. Fatty alcohol ethoxylate and citric acid were then added and the mixture stirred uniformly to obtain a formulation.

### Comparative Example 1

An emuslifiable concentrate (EC) formulation of abamectin 1.8% was prepared from the following components:

| | |
|---|---|
| Abamectin | 1.8% |
| N-hexanol | 60% |
| Castor oil ethoxylate | 30% |
| BHT (antioxidant) | 1% |
| Acetic acid | 0.5% |
| Propylene glycol | 6.7% |

Abamectin was added to n-hexanol according to the above-mentioned weight percentages until dissolved. Thereafter, castor oil ethoxylate, BHT (antioxidant), acetic acid and propylene glycol were added and the resulting mixture stirred uniformly to obtain a comparative formulation.

### Comparative Example 2

An emuslifiable concentrate (EC) formulation of abamectin 1.8% was prepared from the following components:

| | |
|---|---|
| Abamectin | 1.8% |
| Methyl oleate | 60% |
| Castor oil ethoxylate | 30% |
| BHT (antioxidant) | 1% |
| Acetic acid | 0.5% |
| Propylene glycol | 6.7% |

Abamectin was added to methyl oleate until dissolved. Castor oil ethoxylate, BHT (antioxidant), acetic acid and propylene glycol were then added and the resulting mixture stirred uniformly to obtain a comparative formulation.

### Comparative Example 3

An emuslifiable concentrate (EC) formulation of abamectin 1.8% was prepared from the following components:

| | |
|---|---|
| Abamectin | 1.8% |
| N-methyl pyrrolidone | 40% |
| Mixed trimethylbenzene | 20% |
| Castor oil ethoxylate | 30% |
| BHT (antioxidant) | 1% |
| Acetic acid | 0.5% |
| Propylene glycol | 6.7% |

N-methyl pyrrolidone and mixed trimethylbenzene were mixed, after which abamectin was added and stirred until dissolved. Castor oil ethoxylate, BHT (antioxidant), acetic acid and propylene glycol were then added and the resulting mixture stirred uniformly to obtain a comparative formulation.

### Comparative Example 4

An emuslifiable concentrate (EC) formulation of pyraclostrobin 8% was prepared from the following components:

| | |
|---|---|
| Pyraclostrobin | 8% |
| Thionyl chloride | 10% |
| Propylene carbonate | 40% |
| Sodium alkyl sulfosuccinate | 40% |
| BHT (antioxidant) | 2% |

Thionyl chloride and propylene carbonate were mixed uniformly, after which pyraclostrobin was added and stirred until dissolved. Sodium alkyl sulfosuccinate and BHT (antioxidant) were then added and the mixture stirred uniformly to obtain a comparative formulation.

### Comparative Example 5

An emuslifiable concentrate (EC) formulation of cyhalofop-butyl 10% was prepared from the following components:

| | |
|---|---|
| Cyhalofop-butyl | 10% |
| N,N-dimethylformamide | 30% |
| Mineral oil | 15% |
| Castor oil ethoxylate | 40% |
| Glycerol | 5% |

N,N-dimethylformamide and mineral oil were mixed uniformly, after which cyhalofop-butyl was added and stirred until dissolved. Castor oil ethoxylate and glycerol were then added and the resulting mixture stirred uniformly to obtain a comparative formulation.

### Particle Size Test

To test the properties of the EC formulations of the above examples when dispersed in a carrier, the following procedure was followed:

Each of the samples from the above Examples 1 to 8 and Comparative Examples 1 to 5 was diluted by 200 times with water with agitation. The emulsifiable concentrate formulations were uniformly emulsified into oil droplets and uniformly distributed in the dilutions.

The appearance of the dilutions was compared and the particle size of the oil droplets in the dilution were tested using a Malvern particle sizer. The results of the analysis are shown in Table 1a and Table 1 b below.

TABLE 1a

| | Example 1 | Example 2 | Example 3 | Example 4 | Example 5 | Example 6 | Example 7 | Example 8 |
|---|---|---|---|---|---|---|---|---|
| Appearance | Transparent | Transparent | Transparent | Transparent | Transparent | Transparent | Transparent | Transparent |
| of dilution | solution | solution | solution | solution | solution | solution | solution | solution |
| Particle | 15 nm | 18 nm | 23 nm | 20 nm | 18 nm | 25 nm | 16 nm | 19 nm |
| size D₅₀ | | | | | | | | |
| Particle | 45 nm | 52 nm | 55 nm | 56 nm | 58 nm | 58 nm | 46 nm | 53 nm |
| size D₉₉ | | | | | | | | |

TABLE 1b

| | Comparative | Comparative | Comparative | Comparative | Comparative |
|---|---|---|---|---|---|
| | Example 1 | Example 2 | Example 3 | Example 4 | Example 5 |
| Appearance | Milky white | Milky white | Milky white | Milky white | Milky white |
| of dilution | and opaque | and opaque | and opaque | and opaque | and opaque |
| Particle | 520 nm | 550 nm | 612 nm | 650 nm | 820 nm |
| size D₅₀ | | | | | |
| Particle | 885 nm | 905 nm | 964 nm | 1020 nm | 1204 nm |
| size D₉₉ | | | | | |

It can be seen from the above results that the formulations of Examples 1 to 8 prepared according to the present invention show transparent solutions after diluting with water and dispersion. The average particle size D₅₀ distribution of oil droplets is within several tens of nanometers, and the particle size D₉₉ does not exceed 100 nanometers. All the particle sizes are below 60 nanometers. The particle size of the oil droplets is relatively small, and the particle size distribution of the oil droplets is relatively narrow.

When the comparative concentrate formulations were diluted with water, the solution was milky white and opaque. The average particle size D₅₀ of the oil droplets formed was not less than 500 nm. The D₉₉ particle size was greater than 1000 nm. The particle size distribution of the oil droplet was significantly wider than obtained with the formulations of the present invention.

Efficacy Test

### Efficacy Test 1—Two-Spotted Spider Mites

The efficacy of the formulations of the above examples in the control of two-spotted spider mite infestations was tested as follows:

Two-spotted spider mites (Tetranychus urticae) were fed in the laboratory. The number of mites was counted, mites were collected and then placed on healthy young pomelo plants.

Formulations of Example 1 and Comparative Examples 1 to 3 were diluted with 100 L of water and then sprayed onto the plants. The spray was applied in a volume of 3000 L/ha.

The treated plants were kept for 10 days at room temperature and under 80% humidity. The remaining population of the mites was examined and the number of mites was counted. The test results are shown in Table 2.

TABLE 2

| | Dosage of | Two-spotted spider mite | |
|---|---|---|---|
| | abamectin | population (% of the | Efficacy |
| | (g/ha) | original population) | (%) |
| Example 1 | 10 | 4 | 96 |
| Comparative | 10 | 14 | 86 |
| example 1 | | | |
| Comparative | 10 | 14 | 86 |
| example 2 | | | |
| Comparative | 10 | 15 | 85 |
| example 3 | | | |
| Untreated | — | 100 | — |

It can be seen from the results summarized in Table 2 that the efficacy of the formulation of the present invention on the two-spotted spider mites is significantly higher than that of the treatment with comparative formulations. There is at least 10% improvement in the efficacy when using the formulations of the present invention.

### Efficacy Test 2—Two-Spotted Spider Mites

The efficacy of the formulations of the above examples in the control of sharp eyespot infestations was tested as follows:

A wheat field area having relatively uniformed sharp eyespot infestation was selected and treated with 8% pyraclostrobin-containing EC formulations of Example 4, Comparative Example 4 and the commercially available pyraclostrobin (250 g/L)-containing EC (BASF, Europe). A blank control was not subjected to any treatment.

The extent of the occurrence of sharp eyespot 14 days after treatment was examined. The test results are shown in Table 3.

TABLE 3

| | Dosage of | Extent of sharp eyespot |
|---|---|---|
| | pyraclostrobin | infestation at day 14 |
| | (g/ha) | (% of original infestation) |
| Example 4 | 150 | 8 |
| Comparative | 150 | 20 |
| example 4 | | |
| Pyraclostrobin 250 | 150 | 21 |
| g/L EC | | |
| (BASF, Europe) | | |
| Untreated | — | 100 |

It can be seen from the results summarized in Table 3 that the control effect of the pyraclostrobin EC formulation of the present invention on the wheat sharp eyespot is significantly higher than that of the treatment with comparative formulation and conventional formulations. There is an improvement of about 12% when using the formulations of the present invention.

### Efficacy Test 3—Gramineous Weeds

The efficacy of the formulations of the above examples in the control of gramineous weeds in rice fields was tested as follows:

Weeds at the 2 to 4 leaf stage were treated with 10% cyhalofop-butyl-containing EC formulations of Example 6 and Comparative Example 5, and the commercially available 10% cyhalofop-butyl-containing EC formulation (Nanjing Huazhou Pharmaceutical Co., Ltd.). A blank control was not subjected to any treatment.

The effect on gramineous weeds 30 days after treatment was examined. The test results are shown in Table 4.

TABLE 4

| | Dosage of | Efficacy |
|---|---|---|
| | cyhalofop-butyl | at day 30 |
| | (g/ha) | (%) |
| Example 6 | 75 | 96 |
| Comparative example 5 | 75 | 86 |
| Cyhalofop-butyl 10% EC | 75 | 86 |
| (Nanjing Huazhou | | |
| Pharmaceutical Co., Ltd.) | | |
| Untreated | — | — |

It can be seen from the results summarized in Table 4 that the control effect of the cyhalofop-butyl formulation of the present invention on the gramineous weeds is significantly higher than that of the treatment with comparative example. There is an improvement of about 10% when using the formulations of the present invention.

The above examples are only for further explanation of the present invention, and are not intended to limit the present invention, and the solutions obtained by simple adjustment of the above-described embodiments are also within the scope of the present application.

1. An agrochemical formulation comprising:
A: an agrochemically active compound;
B: a solvent system comprising:
a) a saturated monohydric alcohol having 1 to 10 carbon atoms; and
b) a fatty acid ester; and
C: an emulsifier.

2. The agrochemical formulation according to claim 1, wherein the agrochemically active compound is present in an amount of from about 0.1 wt % to about 10 wt % based on the weight of the formulation; and/or wherein the saturated monohydric alcohol solvent having 1 to 10 carbon atoms is present in an amount of from about 10 wt % to about 60 wt % based on the weight of the formulation; and/or wherein the fatty acid ester cosolvent is present in an amount of from about 5 wt % to about 40 wt % based on the weight of the formulation; and/or wherein the emulsifier is present in an amount of from about 5 wt % to about 50 wt % based on the weight of the formulation.

3. The agrochemical formulation according to claim 1, wherein the agrochemically active compound is selected from abamectin, emamectin benzoate, spinosad, spinetoram, imidacloprid, spirotetramat, oxyfluorfen, cyhalofop-butyl, diflufenican, metribuzin, pyriproxyfen, oxadiazon, and mixtures thereof.

4. The agrochemical formulation according to claim 1, wherein the saturated monohydric alcohol is an aliphatic or an alicyclic saturated monohydric alcohol.

5. The agrochemical formulation according to claim 1, wherein the saturated monohydric alcohol has from 3 to 8 carbon atoms.

6. The agrochemical formulation according to claim 1, wherein the fatty acid ester has a general formula of R—COO—CₙH₂ₙ₊₁, in which 1≤n≤10, and R is a linear and/or branched C₉-C₁₉ alkyl and/or alkenyl.

7. A method for preparing the agrochemical formulation of claim 1 the method comprising mixing the agrochemically active compound with a solvent system comprising:
a) a saturated monohydric alcohol having 1 to 10 carbon atoms;
b) a fatty acid ester; and
an emulsifier.

8. A method for improving the particle size distribution of emulsified oil droplets of an emulsifiable concentrate (EC) formulation comprising mixing an agrochemically active compound with a solvent system comprising
a): a saturated monohydric alcohol having 1 to 10 carbon atoms;
b): a fatty acid ester.

9. The method according to claim 8, wherein the agrochemically active compound is selected from abamectin, emamectin benzoate, spinosad, spinetoram, imidacloprid, spirotetramat, oxyfluorfen, cyhalofop-butyl, diflufenican, metribuzin, pyriproxyfen, oxadiazon, and mixtures thereof.

10. The method according to claim 8, wherein the saturated monohydric alcohol is an aliphatic or an alicyclic saturated monohydric alcohol.

11. The method according to claim 8, wherein the saturated monohydric alcohol has from 3 to 8 carbon atoms.

12. The method according to claim 8, wherein the fatty acid ester has a general formula of R—COO—CₙH₂ₙ₊₁, in which 1≤n≤10, and R is a linear and/or branched C₉-C₁₉ alkyl and/or alkenyl.

13. A crop treatment composition comprising an effective amount of the agrochemical formulation of claim 1 and water.

14. A method for treating or protecting a plant and/or plant parts from a pest, comprising contacting the plant, plant parts and/or their surrounding with an agrochemical formulation of claim 1.

15. The use of the agrochemical formulation of claim 1 in treating or protecting a plant and/or plant parts from a pest.
